(19) United States
(12) Patent Application Publication
(10) Pub. No.: US 2016/0140474 A1
(43) Pub. Date: May 19, 2016

(54) SYSTEM AND METHOD FOR AUTOMATED PROJECT PERFORMANCE ANALYSIS AND PROJECT SUCCESS RATE PREDICTION

(71) Applicant: Tenore Ltd., Ra'anana (IL)

(72) Inventors: Alon VEKKER, Tel-Aviv (IL); Ilan Geller, Ramat-Gan (IL); Shirly Dorfman, Kfar Yona (IL)

(21) Appl. No.: 14/543,993

(22) Filed: Nov. 18, 2014

(51) Int. Cl. G06Q 10/06

(52) U.S. Cl. CPC G06Q 10/06393

(57) ABSTRACT

A system and method for predicting a performance of a project. Input data may generated based on data related to one or more managerial systems of an organization; data related to one or more projects the organization is currently working on; and historical data related to one or more past projects. A benchmark may be generated based on events related to projects in one or more organizations. The input data and the benchmark may be used to generate a prediction of at least one future event related to the project.

### FIELD OF THE INVENTION

The present invention relates generally to predicting a future of a project. More specifically, the present invention relates to methods, devices and systems for predicting or forecasting aspects such as a success, cost or timely completion of a project.

### BACKGROUND

The goal of project management is a successful project. For example, meeting time constraints or schedules, budget constraints and resource usage are common objectives of project management that typically determine success or failure of a project. Although monitoring specific aspects of a project, e.g., a schedule or a budget are known in the art, there is a need in the art for a comprehensive system and/or method for predicting a future (e.g., success or failure) of a project.

### SUMMARY

A system and method for predicting a performance of a project are described. Input data may generated based on data related to one or more managerial systems of an organization; data related to one or more projects the organization is currently working on; and historical data related to one or more past projects. A benchmark may be generated based on events related to projects in one or more organizations. The input data and the benchmark may be used to generate a prediction of at least one future event related to the project.

Generating a benchmark may be based on at least one of: a time schedule of a project and resource allocation of a project. Generating a prediction of a future event may comprise processing data related to at least one of: tasks, resources, schedules of the project, history of the project, Gantt charts of the project and the benchmark. A system and method may generate a behavior and schedule prediction of a project based on relating patterns, events and statistical deductions of the project with data in a database.

Input data used for predicting a performance of a project may be generated based on information collected from a relevant community. Input data used for predicting a performance of a project may be related to a past behavior of a resource used for the project. Input data used for predicting a performance of a project may be related to resource profiling information related to at least one of: a performance, a scheduling accuracy and an average delay in completing tasks.

Generating a prediction of at least one future event related to a project may include determining a projected workload of a resource. A system and method may generate a recommendation usable for improving a performance of the project based on analyzing an impact of changes on an outcome of one or more other projects. Generating a prediction for a project may include using information produced by machine learning of the input data and at least one event related to one of: the project and another project.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows high level block diagram of an exemplary computing device according to embodiments of the present invention;

FIG. 2 is an overview of a system according to embodiments of the present invention;

FIG. 3 shows a system according to embodiments of the present invention;

FIG. 4 is a high level block diagram of a system and related input and output according to embodiments of the present invention;

FIG. 5 shows a system and flows according to embodiments of the present;

FIG. 6 shows a flowchart of a method of predicting a performance of a project according to an embodiment of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

The terms “crowdsource” and “crowdsourcing” as referred to herein may relate to obtaining content from a group of people. For example, receiving input from employees in a company regarding a project, or resource of a project, may be referred to herein as crowdsourcing, and the information obtained from the employees may be referred to as crowdsource information. Crowdsource information may be collected or obtained from customers or clients of a company, from experts in a specific field and so on. For example, questionnaires (e.g., filled in online over a network) may be used to collect crowdsource information from customers, or from employees in an organization. A system and method may include collecting data submitted by a large group of people or community (the “crowd”), e.g., through an open call, over a network etc. Crowdsource information may be collected and used to generate a prediction as described herein.

A project as referred to herein may be as known in the art. A project as referred to herein may include tasks, activities, resources, management and plans. A project may include, or may be the process and activity of planning, organizing, controlling resources, procedures and protocols to achieve specific goal. For example, all aspects, as viewed by a company, related to developing a software product or application may be a project. A project may include activities, resources and plans related to scheduling, resource allocation, management and the like. For example, a budget may be included in a project or it may be assigned or allocated to a project, engineers and computers may belong to a project or be assigned to the project and so on. An event may be any event related to a project. For example, shipment of a product developed by the project, beginning a task included in the project (e.g., quality assurance, developing a version etc.). An outcome may be a product or it may be an event, e.g., meeting a deadline may be an outcome. Another example of an outcome or event may be missing a deadline. For example, a project's plan (e.g., Gantt charts known in the art) may include a time for beginning a task and an event or outcome may be a delay and/or changing the time for beginning the task.

Gantt charts (or just “Gantt” as referred to in the art) are known in the art, typically used for planning, monitoring or tracking progress of a project. Gantt charts may be used to present data stored in a system. Gantt charts may be used herein to refer to any data or information presented, stored or otherwise related to a system that supports Gantt data and Gant charts. A typical Gantt chart shows progress of tasks (either planned or actual) in relation to time. For example, a Gantt chart shows activity planned to take place during specified periods, which are indicated in vertical bands

Generally, online as referred to herein includes interacting with a system or method over a network. For example, an online service may include using a home computer or smart-phone for requesting and receiving a service from a server over a network.

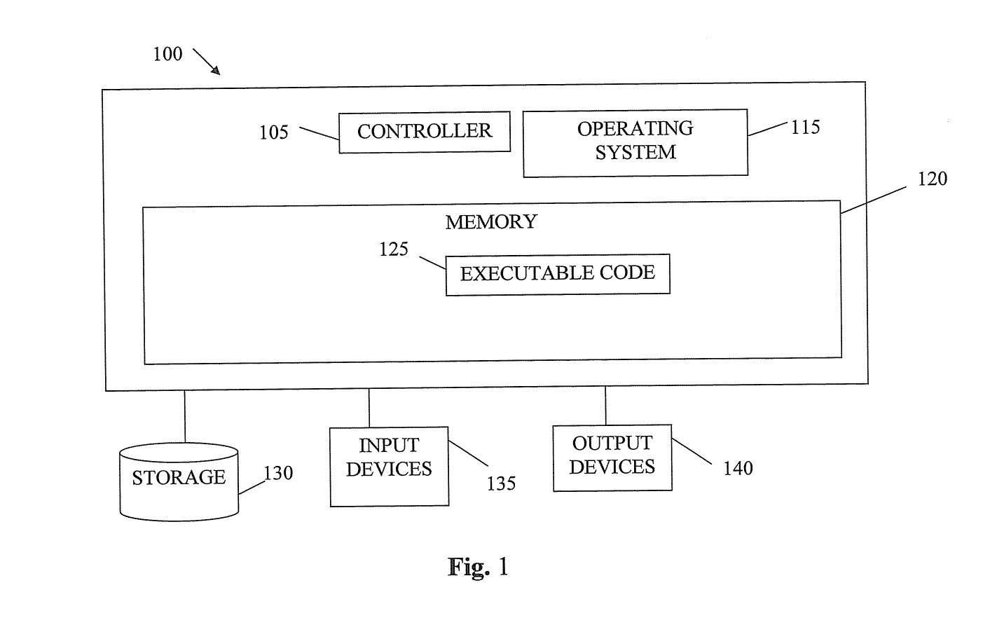

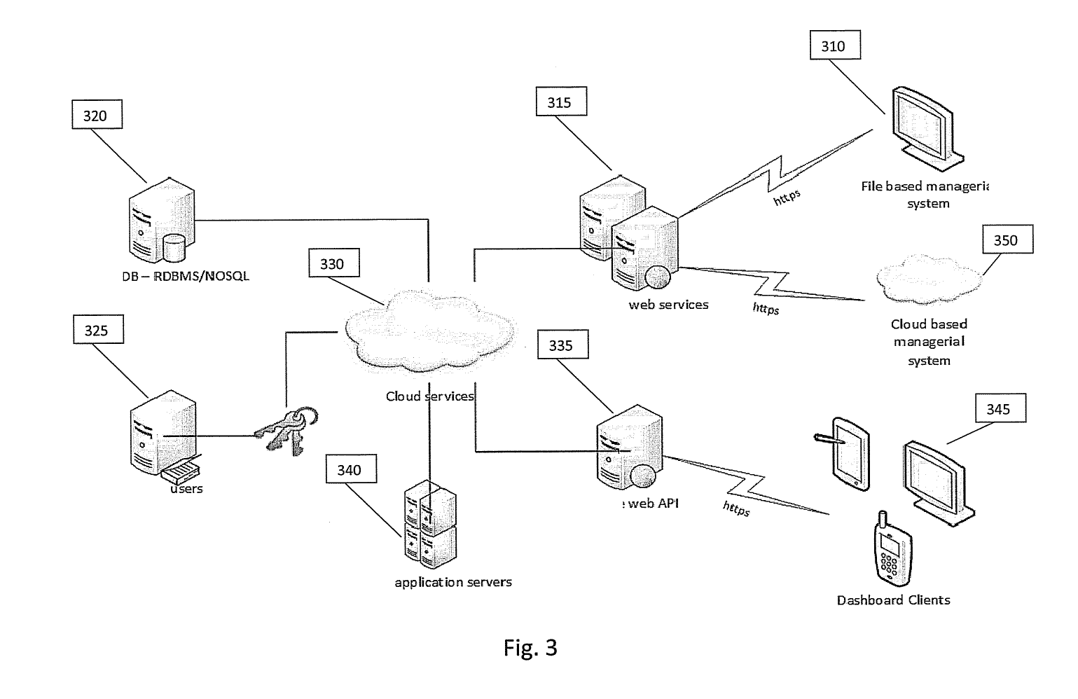

Reference is made to FIG. 1, showing a high level block diagram of an exemplary computing device according to embodiments of the present invention. Computing device 100 may include a controller 105 that may be, for example, a central processing unit processor (CPU), a chip or any suitable computing or computational device, an operating system 115, a memory 120, an executable code 125, a storage 130, input devices 135 and output devices 140. Controller 105 may be configured to carry out methods described herein, and/or to execute or act as the various modules, units, etc. More than one computing device 100 may be included, and one or more computing devices 100 may act as the various components, for example the components shown in FIG. 3. For example, by executing executable code 125 stored in memory 120, controller 105 may be configured to carry out a method of predicting a performance of a project that may include using data related to one or more projects, historical data related to one or more past projects and a benchmark to generate a prediction of at least one future event related to the project. For example, controller 105 may be configured to generate a benchmark based on events related to projects, receive input data that includes: data related to one or more managerial systems of an organization; data related to one or more projects the organization is currently working on; and historical data related to one or more past projects, and use the input data and the benchmark to generate a prediction as described herein.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or enabling software programs or other modules or units to communicate. Operating system 115 may be a commercial operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that performs project performance analysis and project success rate prediction as further described herein. Although, for the sake of clarity, a single item of executable code 125 is shown in FIG. 1, a system according to embodiments of the invention may include a plurality of executable code segments similar to executable code 125 that may be loaded into memory 120 and cause controller 105 to carry out methods described herein. For example, units or modules described herein may be, or may include, controller 105 and executable code 125.

Storage 130 may be or may include, for example, a hard disk drive, a floppy disk drive, a Compact Disk (CD) drive, a CD-Recordable (CD-R) drive, a Blu-ray (BD) disc, a universal serial bus (USB) device or other suitable removable and/or fixed storage unit. Content may be stored in storage 130 and may be loaded from storage 130 into memory 120 where it may be processed by controller 105. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays or monitors, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a printer, a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105.

Some embodiments may be provided in a computer program product that may include a non-transitory machine-readable medium, stored thereon instructions, which may be used to program a computer, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more devices such as computing device 100.

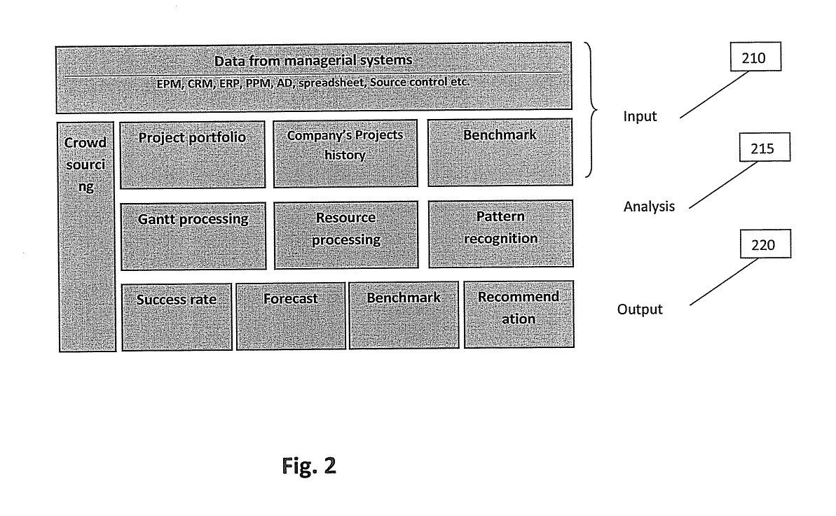

Reference is made to FIG. 2, an overview of a system and elements according to embodiments of the present invention. As shown by input 210, input to a system or method may include data from, or related to, managerial systems. For example, data obtained from managerial systems may be a work breakdown structure of a project with tasks data and resource allocation data for the tasks. Where applicable, units shown by input 210, analysis 215 and output 220, and other components and units described herein, may be similar to, or may include components of, device 100 described herein. For example, Gantt charts and resource processing units may be or may include a controller 105, memory 120 and executable code 125. In some embodiments, units shown in FIG. 2 and elsewhere may be tasks or applications executed by controller 105.

For example, a collection unit may retrieve or obtain input as shown by 210 from systems such as an Enterprise Project Management (EPM) system, a Customer Relationship Management (CRM) system, an Active Directory (AD) system, an Enterprise Resource Planning (ERP) system or a Product Portfolio Management (PPM) system as well as data in or from spreadsheets or source control data etc. For example, using an application programming interface (API) provided with an EPM system, a module or unit that includes controller 105, and executable code 125 in memory 120 may retrieve any information from the EPM system.

Input 210 may include data from any collection of tools used in an organization to manage and monitor project portfolio related data. For example, data from tools or applications that store data on project and tasks progress, resource leveling, financing issues, budgets and the like. For example, input may be received from tools or applications such as MS Project, SAP, and Salesforce. As described herein, a system and method may enable a one stop solution with an intuitive dashboard to review information from multiple systems and sources, and may assist with a management decision-making process.

Input 210 may include any data related to project portfolio. For example, in one embodiment, project portfolio or data related to project portfolio is data related to all currently running or ongoing projects in an organization, e.g., data that was received from a managerial system as described herein. A project portfolio or data related to a project portfolio may be related to a past project. For example, a portfolio of a past project may include both estimates or plans made before the project ended, e.g., data collected at a planning stage or prior to completion of the project and actual resource usage and timely termination of tasks (as known when the project ended).

Input 210 may include data related to current projects. A current project may be an ongoing project or a project a company is currently working on or involved in. For example, resource allocation, time spent, budget and the like related to projects that a company or organization is currently involved in, or working on may be included in input 210. Information related to current projects may be, or may be based on, data from a company's managerial systems (e.g., a PPM tool or application). Information or data related to current projects may be converted to a standard or predefined format and may be stored in a system's database that may reside on a cloud service. For example, data from a managerial system may be converted or re-formatted and stored on database 220. For example, an agent module may use managerial information to create a snapshot or summary of a project state or portfolio and may update database 220, e.g., on a daily basis. A managerial system may be for example any system enabling or helping a management of a project. Typically, a managerial system stores and presents data, e.g., Gantt charts, employees' data, resource information and the like. A managerial system may include a set of standard operating procedures related to a business, structures and procedures for directing actions and activities toward company goals and so on. A managerial system may be a commercial system as known in the art, e.g., project portfolio management (PPM) provided by Microsoft.

Input 210 may include any data related to historical or past projects or events. For example, data related to historical or past events or projects may include a company's historical data that may be data gathered over time from managerial systems, analysis results related to a company's project and predictions calculated or computed for past projects (e.g., past projects that the company or organization worked on), e.g., as described herein. In one embodiment, historical data is a collection of projects portfolio snapshots from all past project portfolios. Historical data may include patterns that were matched with statistics and resource profiles. Predictions may be any output or insights produced by an analysis of past projects.

For example, a project's historical data may include all the project's Gantt charts or files with the work breakdown structure (WBS) and resource spending, data from an enterprise project management (EPM) application, historical data may include sales number and budget spent on each version of a product developed in a project, e.g., from a CRM application. Historical data may include revisions of data, e.g., from different time points in the life of projects.

Input 210 may include an industry benchmark. An industry benchmark (or “benchmark” as referred to herein) may include a list of events that had been seen in several organizations, and statistical deductions made based on the events. When there is statistical significance for an event across a predefined number (or threshold, e.g. 20) companies, the event may be added to the industry benchmark. The events, patterns and/or deductions used for updating or generating a benchmark may be related to a large number of projects in a large number of organizations or industries. For example, a benchmark may be related to a specific industry, a specific type of organization, a country etc. In some embodiments, a first benchmark may be relevant to multiple industries and a second benchmark may be related or relevant only to a specific industry.

A benchmark may include data for a specific aspect of a project. In an embodiment, a value in a benchmark may be related to quality assurance (QA). For example, by examining data related to a large number of projects, it may be determined that 15% of an average project's budget is spent on QA, accordingly, 15% of budget spent on QA may be included in a benchmark. If the spending on QA in a current project is significantly less than 15% an alert may be generated. For example, in the scenario of less than 15% spent on QA, a prediction of a project's success or outcome may be based on the fact that not enough money is spent on QA. A benchmark may be generated based on data produced by Gantt (or Gantt charts) processing as further described herein.

As shown by analysis 215, a system may include an analysis layer or unit. An analysis unit or module may process data in company's project portfolio, e.g., Gantt charts of the project, and generate a forecast for the projects schedule. As shown by analysis 215, analysis may include Gantt processing (e.g., processing Gantt charts, Gantt files or any Gantt related data), resource processing and pattern recognition. For example, analysis unit 215 may analyze any input included in input 210 to produce output 220

Analysis of data may include identification of tasks based on their names, description or other information. For example, analysis of data may include identifying a type of a task using Neuro-Linguistic Programming (NLP) as described.

Analysis of data may include comparing or otherwise relating data related to a project to data historical data. For example, to analyze a task, a processing unit may look for similar tasks in past projects and identify the task, needed resources and the like based on past projects' data.

Analysis of data may include comparing a chain of tasks in a project to similar chains in past projects. For example, the same sequence of tasks may be repeated in multiple projects (e.g., development, QA, beta, etc.). Analysis of data may include evaluating of resources by analyzing their performance, e.g., capacity to complete tasks, rate of depletion etc.

For example, to perform Gantt chart processing, an analysis unit may receive as input the latest Gantt chart or revision of a specific project (also referred to herein as “Project Gantt”), a company's project history, data in an industry benchmark and crowdsource information and calculate, generate or produce a project schedule forecast and predictions for future projects events.

An analysis unit or module may perform resource processing. Resource processing may include evaluating resource workload and efficiency using any of: historical information, a company's project portfolio, data from managerial systems (e.g., EPM, source control tools etc.) and crowdsource information.

For example, a unit may receive as input a company's project portfolio, a company's project history, data in an industry benchmark and crowdsource information and use the input to calculate, generate, or produce a resource projected workload. For example, a resource projected workload may indicate a resource is expected to be exhausted (e.g., reach a 132% utilization) or a resource projected workload may indicate the resource utilization is within a safe, predefined range (e.g., 80%).

An analysis unit or module may perform analysis 215 that may include pattern recognition. Pattern recognition may be an automated learning process that may include pattern recognition/creation and adding patterns to a database. Pattern recognition may be an automated process that includes matching or comparing a current project's Gantt data (e.g., stored in Gantt charts) with known patterns in a database. Based on patterns that were matched, a process or unit may deduce or forecast a behavior of a project and may generate a prediction of future events of the project. For example, a future event may be a date when the project will be completed, a date when a specific resource will be exhausted etc. A learning process or unit may update patterns in a database, for example, when a system or method detects a possible or required change in its logic (or knowledge); the relevant patterns are updated in a database.

A prediction may be for example a message (e.g., displayed on a monitor of a computer or sent as electronic mail) or other information or data related to a future state or likely future state. A prediction may for example include a predicted event. For example, a prediction may be an electronic mail message sent to a predefined recipient list that informs that a project will or is likely to fail to meet a deadline. For example, a prediction may be the message “the quality assurance phase is expected to be delayed by three weeks”.

Output 220 may include a success rate (SR) that may indicate the ability of a project to meet its schedule, resource assignment and scope constraints. Output 220 may include a forecast for a project. For example, producing a forecast may include Gantt chart processing according to a method as described herein. A system or method may include Gantt chart processing that may produce a project schedule forecast that may be, or may include, a prediction of how each task; milestone or other aspects of a project will behave in the future.

Gantt chart processing may include generating a projected schedule for the whole project based on project data for tasks, milestones, tasks relationships, resources and resource allocation for tasks, e.g., obtained from WBS or Gantt charts. Processing of Gantt data or other data (e.g., from managerial systems) may include generating a forecast, e.g., the finish date of the project, probabilities of a number of finish or completion dates, forecasted resources costs for the project (e.g., with an indication of more or less than planned), what features will be available when the project is completed and so on.

Output 220 may include a benchmark. For example, new patterns discovered or identified may be used to update statistical deductions in a benchmark database, e.g., after a project is finished. A system and method may include a learning unit or process that may generate, update or improve a benchmark based on patterns or other parameters calculated as described herein.

For example, assuming a project that includes developing a software application typically includes tasks A, B and C where A is the design task, B is the preliminary design review task or process and C is the production of a final design of the application, by studying a large number of projects it may be deduced, automatically be a system or method, that B is followed by A, B is followed by C. A system or method may generate and use an exemplary rule or threshold, e.g., in the example above, if task ‘A’ wasn't completed before task ‘B’ then task ‘C’ has a 30% chance of being completed as planned. Generally, a learning method, module or device may examine data of past and current projects and generate rules such as the one described above with relation to an exemplary project of developing a software application. Rules may be generated and used for any relevant aspect of a project, e.g., if more than 56% of the budget was spent when only 45% percent of the tasks are completed than the project has an 80% chance or probability to exceed its budget by 125% percent. Such rules, criteria or thresholds may be deduced or generated by a learning module that may apply various statistical analyses on data from managerial systems, crowdsourcing, data related to past and current projects, data related to a relevant community or any other data related to a project.

Output 220 may include a recommendation. For example, changes in a project portfolio schedule may be monitored or identified. When a project finishes, a system or method may analyze the impact of each past changes on the project's outcome. Based on a forecast and past experience (e.g., the impact of changes in the past) a system or method may generate a recommendation regarding what can be done to improve the success rate of a current running project. A system and method may include in a recommendation the impact of a change on the project, e.g., in terms of resource allocation, budget and project time to market (TTM).

Output 220 may include recommendations based on changes in the projects itself. For example, if tasks are added to a project then a system may automatically recommend an increase of the workforce assigned to the project. Output 220 may include alerts. For example, based on changes in the present or other projects in a portfolio, a system may calculate (or re-calculate) an outcome or event, and an alert or recommendation may be generated. For example, a change in any one of: crowdsource data, data from managerial systems, benchmark and resource profiles may cause a system and method to re-calculate an event such as a completion of task or project.

A system and method may use NLP to process textual data obtained from managerial system, such as tasks names, to add better understanding to structural data and use processed data as input to a process of predicting an outcome or event of a project.

A system and method may use data mining techniques and statistical analysis to search for past industry and company insights. For example, data mining may be used to search benchmark data, extract information from a data set and transform information into an understandable structure for further use.

A system and method may use crowdsourcing to refine results in a prediction of an outcome of a project, e.g., crowdsourcing may include obtaining information from employees of a company involved in the project. NLP, data mining and crowdsourcing processing may be combined by a system or method in order to generate a prediction, forecast, recommendation and/or benchmark as described herein. NLP, data mining and crowdsourcing (e.g., employees' opinions) may be used by a system or method in order to analyze project schedules and/or create resource profiles.

As known in the art, NLP can be used to analyze textual data. For example, NLP may be used to analyze, identify or classify task names, notes or description in any data. For example, NLP may be used to identify a task named “Check all the new classes in the added VS project” a task of type QA even if the term “QA” is not specifically mentioned.

Crowdsourcing or crowdsource data may be used in order to complete or augment data. For example, based on answers from employees, a method may determine how long a task will take to complete. In another example, if an NLP process fails to identify a type of a class, a question (e.g., “what is the type of task <task name>?”) may be automatically generated. For example, if an NLP process fails to identify or classify a task named “cycle 1”, (e.g., 1st cycle of the QA process) then <task name> may be automatically replaced with cycle 1 and the resulting question may be provided to a community (e.g., the employees in a specific department).

Reference is made to FIG. 3, a system according to embodiments of the present invention. As shown by FIG. 3, a system may include a file based managerial system 310, web services provided by servers 315, a database 320, computers 325 storing users data, a network 330 that may be the internet or any other suitable network, a web API server 335, application servers 340, dashboard clients computing devices 345 and a cloud based managerial system 350. A connection between users of computers 325 and cloud services 330 may be secured as indicated by the keys shown on the line connecting blocks 325 and 330. The connection between, dashboard clients 345, cloud based managerial system 350, file based managerial system 310 and web services 315 may be secured as indicated by https which stands for hypertext transfer protocol secure.

File based managerial system 310 may be a collection of tools that are used in an organization to manage and monitor project portfolio related data. These tools may store data on projects' and tasks' progress, resource leveling, financing issues, budgets and more. These tools may include PPM software such as MS Project, ERP solution such as SAP, and CRM tools such as Salesforce. The data for those systems may be stored locally in the organization in the form of files.

Web services provided by servers 315 may be a collection of services hosted by servers 315 and that provide services that are used for the input to the system. A system may use the services to get or receive data from managerial systems, convert the data to an internal system format and send formatted data to a database for storage. The services may also trigger an alert (e.g., a recommendation as described herein) based on the data, or notify an application server for further analysis.

Database 320 may be a relational database server (RDBMS) or data storage system distributed on several servers for queries (e.g., No-SQL). Database 320 may store all the system data in a standard format. Stored data may be read by an application server for analysis and/or obtained, e.g., using Web API, for viewing, e.g., using a clients' dashboard as described herein.

Computers or servers 325 may store system user data for authentication and authorization to the different parts of the system. Network 330 may be the Internet or it may be an internal network (e.g., an Intranet) and may enable system components to communicate and transfer data to each other using a secure method of communication. Web API Server 335 may support, host or provide a collection of web services. For example, services that are used for the output of the system. An external client can access the web services using a secure API with the right privileges to get the analyzed system data and present it in an understandable way. For example, executive dashboards that can show for each project its success score.

Application servers 340 may perform analysis of data as described herein. Application servers 340 may perform the calculation and processing needed for the system input, such as Gantt charts and resource processing and pattern recognition. Application servers 340 may use the data for the external system that is stored in the database for the analysis and then output results, such as success rates, project forecast and recommendation back to the database. Application servers 340 may generate crowdsourcing questions as described herein and may processes answers to questionnaires as described herein.

Dashboard clients 345 may be a frontend for the application. The insight generated by a system may be conveniently viewed on or by a frontend such as a web based application, client application or a mobile application. Dashboard clients 345 may be used to present insights related to a crowdsourcing process.

Cloud based managerial system 350 may be similar to file based managerial system 310 but may be a remote system that stores data on the cloud (e.g., a server on the internet). Access to data stored on cloud based managerial system 350 may require authentication.

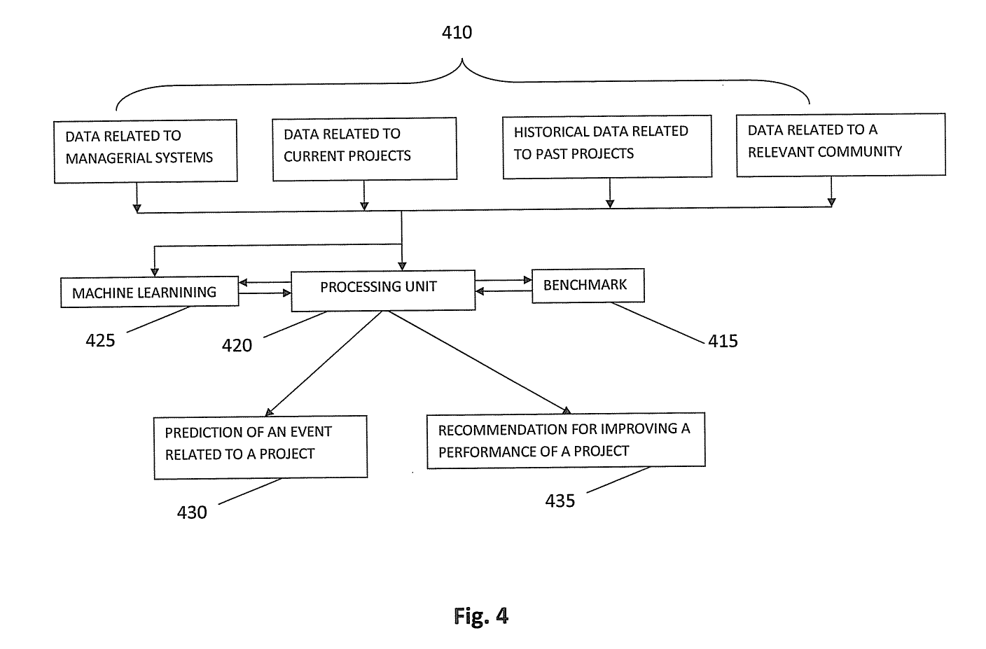

Reference is made to FIG. 4, a high level block diagram of a system and related input and output according to embodiments of the present invention. As shown by inputs 410, input to a system and method may include data related to managerial systems, data related to current projects, historical data related to past projects and data related to a relevant community. As shown, inputs may be provided to a processing unit 420 that may use a benchmark 415 and machine learning 425 in order to produce output. For example, output may be prediction 430 and/or recommendation 435 as shown. It will be understood that the system shown in FIG. 4 is a simplified one. For example, a plurality of processing units 420 may be used. For example, a first processing unit (e.g., in included in web services 315) may retrieve data from managerial systems, a second processing unit (e.g., included in application servers 340) may perform analysis as described herein and a third processing unit (e.g., included in web API 335) may provide predictions and/or recommendations to users' devices. By using or combining inputs from a range of sources as shown by inputs 410, a benchmark as shown by benchmark 415 and machine learning 425, a system and method may generate predictions and recommendations as further described herein. Where applicable, any unit or module described herein may be, or may include device 100 or components of device 100. For example, each of: processing unit 420; benchmark 415; machine learning 425; crowdsourcing integration unit 515; recommendation generation unit 560; processing unit 525 may include components of device 100. Servers (e.g., servers 315 and other servers shown in FIG. 3) may be or may include device 100. Services (e.g., cloud services 330) may be executed or provided by controller 105.

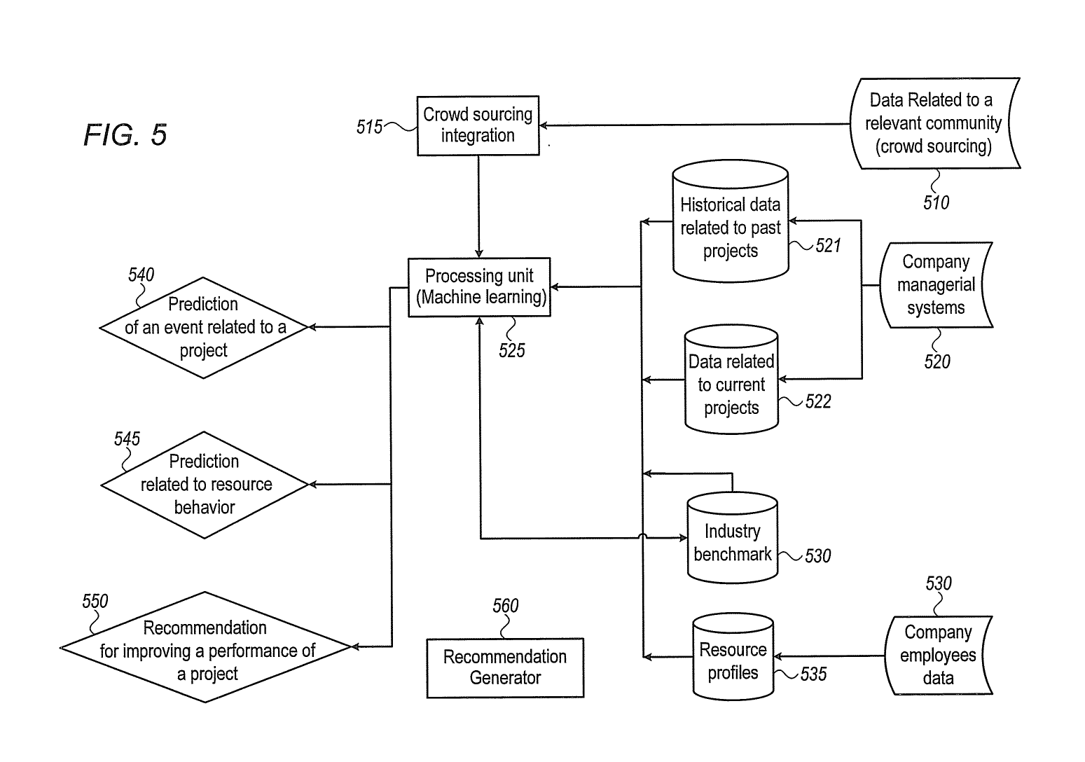

Reference is made to FIG. 5, a system and flows according to embodiments of the present invention. As shown in FIG. 5, a system may include a number of units or modules. For example, a system may include a crowdsourcing integration unit 515, a recommendation generation unit 560 and a processing unit 525. Modules or units 515, 525 and 560 may be similar to or included in, or executed by, device 100. Modules or units 515, 525 and 560 may include components included in device 100. For example, each of units 515, 525 and 560 may include a controller 105, a memory 120 and executable code 125. In some embodiments, units 515, 525 and 560 may share components. For example, a single controller 105 may be used to implement units 515, 525 and 560.

As shown by crowdsourcing 510, data from, or related to, relevant communities may be provided or obtained as input to a crowdsourcing integration unit 515. For example, crowdsourcing integration unit 515 may include a questions generator unit that may generate questions to a crowd. For example, a question generator unit may generate questions to employees in a company and produce crowdsource information using employees' answers.

For example, a questions generator unit may generate or obtain a survey or questionnaire and send the survey to employees (e.g., using electronic mail and a list of recipients). Employees may fill out the survey in order to provide their answers and return the answers using electronic mail. In other cases, a survey may be provided online (e.g., as a form in a web page) and users may fill the survey using a web browser.

Crowdsourcing integration unit 515 may update a database based on the answers. For example, the crowdsourcing integration unit 515 may process answers (e.g., format answers according to a predefined format) and may provide the answers to processing unit 520 as shown. Processing unit 520 may be, or may be similar to, processing unit 420.

Crowdsourcing integration unit 515 may automatically generate questions, send automatically generated questions to selected recipients and receive answers to the questions. For example, in a Gantt (e.g., Gantt chart or other data stored in a system that supports Gant data) of a project, task “Y” may be allocated 5 days of work. To generate or refine an estimated completion of task “Y”, crowdsourcing integration unit 515 may generate a question such as “Do you estimate that task Y will take 5 days to complete?” and send the question to a selected set of recipients.

The list of recipients for automatically generated questions or questionnaires may be automatically selected or generated. For example, based on data in company managerial systems 520 and data in company employees' data 530, crowdsourcing integration unit 515 may determine or select sets of employees that are relevant to a project or task and send questions related to the project or task to the selected sets. For example, if task “Y” is included in a project of the Research and Development (R&D) department, crowdsourcing integration unit 515 may send the question related to task “Y” to engineers or other members of the R&D department.

Responses or answers to automatically generated questions may be used to generate a prediction or recommendation. For example, if some, or the majority of the responses or answers to the exemplary question related to task “Y” is “No”, or “I think task “Y” will need more time” or “I think task “Y” will take 7 days” then crowdsourcing integration unit 515 or processing unit 525 may generate a prediction that task “Y” will take 6 or 7 days. Any algorithm or method may be used in order to process responses or answers to automated questionnaires or questions. For example, NLP may be used to process answers or responses and determine the effect of the answers on a prediction or recommendation.

It will be understood an automated process of generating and sending or providing questions and processing responses or answers may be applicable to many aspects. For example, a question may be related to “time to market” of a product and an estimated time of reaching the market may be changed based on the answers. For example, the whole project duration may be increased in a WBS if a task assessed using automated questions is in a project's critical path. Another example may be related to human resource (HR). For example, a question automatically generated by crowdsourcing integration unit 515 may be “How do you feel about the management engagement in the project?”. Many negative answers to this kind of question may cause processing unit 525to generate an alert or send an email to the management of the company, alerting that a problem exists.

Processing responses or answers to automatically generated questions may be based on ranks, scores or grades of the source of the answers. For example, responses from employees may be recorded and compared to outcomes of projects, task completion time etc. An employee that consistently appears to provide relevant answers (e.g., consistently correctly estimates duration of tasks) may be given a high rank or score and responses from that employee may be given higher weights in a process of generating estimations or recommendations.

In some embodiments, each recipient of questions is associated with a set of scores for a respective set of categories. For example, an employee may have a score of 0.8 in the category of schedule and a score of 0.9 in the category of budget. Scores may be set according to a match of answers with an average of the answers, according to a match of the answers with actual outcomes and so on.

As shown by company managerial systems 520, data from managerial systems may be retrieved and identified as historical data related to past projects 521 and data related to current projects 522. Data from managerial systems may be converted, by a conversion unit, to a standard format and stored in a database of historical and current data. For example, a module or unit on servers 315 may convert data from various organizational managerial systems, such as MS Project or Oracle Primavera, to standard format and store formatted data on database 320 or on any storage where the formatted data is accessible to other modules or units in a system.

Employees' data may be obtained from various sources as shown by company employees' data 530. For example, employees' data may be obtained from an identity management system that may include employees' positions in the company, usernames, salaries etc. Employees' data may be obtained from an EPM system and may include work hours, absence, maintenance hours etc. Employees' data may be obtained from a CRM system and include amount of client connections an employee has and the like.

Resource profiles may be generated as shown by resource profiles 535. Resource profiles 535 may be generated or created by processing unit 525 that may use information in any of: data related to relevant communities 510; company managerial system 520; and company employees data 530 to create, generate or update resource profiles 535. For example, employee's data and data related to other resources (e.g., budget, computers, and fleet) may be provided to a resource profiler unit that may generate profiles of resources. A resource profile included in resource profiles 535 may include elements such as names, salaries, monthly work hours, overhead times, capacity, percent of tasks completed on time or as planned, average delay in milestone delivered and so on.

A profile of a resource may include scores or quality values that may indicate the quality or value of the resource. A resource may include scores for different tasks or aspects. For example, a resource profile of an engineer may include the values of 0.9 for web development, 0.3 for integration and 0.5 for bug fixes. Accordingly, a system may automatically estimate outcomes (e.g., time to finish a task) based on profiles of resources. For example, if the task to be completed by a team of engineers is integration and the resource profiles of many of the engineers in the team include low scores or quality values with respect to integration, then processing unit 525 may generate a prediction that the task will take more than planned. In this example, processing unit 525 may generate a recommendation to add to the team engineers better suited for the job. For example, processing unit 525 may examine resource profiles of engineers, identify engineers with high score in the field of integration, and suggest adding those engineers to the team.

As shown resource profiles may be provided to processing unit 525. For example, a system may include a database of resource profiles that may be generated and/or updated by the resource profiler module or unit. For example, a resource profiles database or storage may include profiles of employees or profiles of other resources, e.g., budget, paid by usage or licensed applications, vehicles, computers, materials and the like. Resource behavior prediction may be based on resource profiles as well as based on historical data in a database and an industry benchmark as described herein. To generate resource profiles, resource workloads and efficiencies may be identified or determined using historical data gathered as described herein, e.g., data from a company's project portfolio, EPM system, source control tools, and crowdsourcing.

Processing unit 525 may use resource profiles to generate, predictions of future behavior of resources. Processing unit 525 may be or be included in or have its functionality included in computing device 100 or controller 105. Processing unit 525 may use some or all of: resource profiles, data from managerial systems, data from a benchmark and crowdsource data to predict a behavior of a resource. For example, it may be predicted that a resource will be exhausted before the project is finished.

As shown, in an embodiment, processing unit and machine learning 525 is provided with data from managerial systems, resource profiles, data from a benchmark and crowdsource data. In an embodiment, processing unit and machine learning 525 uses input data to generate a prediction of an event related to a project 540, prediction related to a behavior of a resource 545 and recommendation for improving performance of a project 550. For example, processing unit and machine learning 525 may be included in a web serve module (e.g., one of application servers 340) that calculates a prediction and success rate for projects based on input data as shown in FIG. 5.

Predictions and success rates may be provided to a dashboard.

For example, predictions and success rates may be graphical content and/or audio content presented and/or provided by output devices 140 that may for example include a monitor and speakers. Some embodiments include a dashboard that may be an application that presents predictions and success rates to users, e.g., on a personal computer or smart-phone. In one embodiment, a dashboard is a frontend application executed on a user device (e.g., a personal computer or smart-phone). The frontend application may provide any or all data that is relevant to a decision maker. In an embodiment, the dashboard is an application (e.g., plug-in) in a web browser that presents recommendations and predictions generated by a by a web server (e.g., one of servers 340).

Recommendations generator 560 unit (that may be included in processing unit 525) may be provided with data provided to processing unit 525. In an embodiment, recommendations generator 560 is provided with a resource behavior prediction as described herein and may generate and provide recommendations. Recommendations may be presented to a user, e.g., by a frontend applications as described herein.

Processing unit 525 may be provided with constraint or scenario and generate a prediction based on the constraint or scenario and based on resource profiles and other input as described. For example, processing unit 525 may receive a change from a user and calculate (or re-calculate) an event, prediction or recommendation based on the change. For example, a user may input a change such as a new task's duration, a decrease in the number of employees assigned to a task, or a change in usage of a resource. Based on a change, constraint or scenario received from a user, processing unit 525 may re-calculate an event such as completion of a project or exhaustion of a resource. Accordingly, a user may be provided with an outcome of a project based on various conditions, constraints or scenarios. Accordingly, a system and method may simulate a performance or behavior of a project or resource based on user's input where the user's input may be related to any aspect of a project, e.g., user's input may be a time required to complete a task, a rate of using or exhausting a resource and the like.

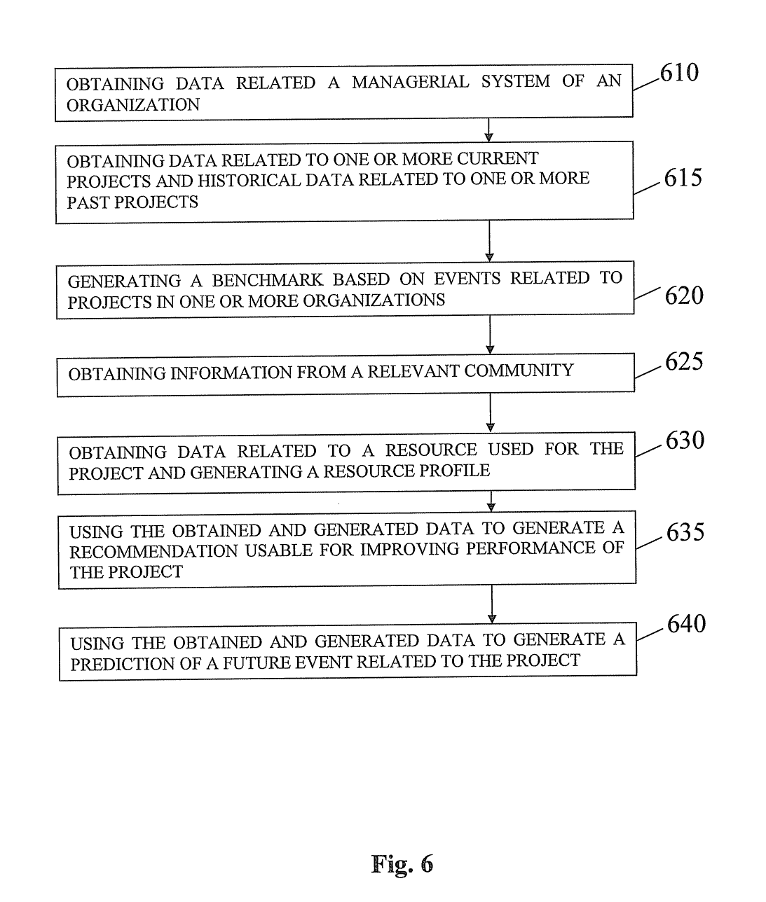

Reference is made to FIG. 6 which is a flowchart of a method of predicting a performance of a project according to an embodiment of the present invention.

As shown by block 610, a system and method may include obtaining data related a managerial system of an organization. For example, data from managerial systems such as MS Project or Oracle Primavera may be obtained (e.g., by a module in servers 315 that uses APIs provided by the managerial systems). As described herein, the unit or module in servers 315 may convert or format data from managerial systems to a format known by other components of a system.

As shown by block 615, a system and method may include obtaining data related to one or more current projects and historical data related to one or more past projects. For example, managerial systems may store or maintain data related to both current and past projects, accordingly, by retrieving data from managerial systems, data related to current and past projects may be obtained.

As shown by block 620, a system and method may include generating a benchmark based on events related to projects in one or more organizations. For example, a benchmark may include a list of events seen in several organizations and statistical deductions that had been calculated based on events seen. Data in a benchmark may be used to refine predictions generated by a system as described herein.

As shown by block 625, a system and method may include obtaining information from a relevant community. For example, crowdsourcing may be used as described herein.

As shown by block 630, a system and method may include obtaining data related to a resource used for the project and generating a resource profile. For example, a profile may indicate the speed or rate according to which a resource is used or depleted. For example, the rate by which money is spent or the time required for completing programming of a given number of tasks may be included in a profile.

As shown by block 635, a system and method may include using the obtained and generated data to generate a recommendation usable for improving performance of the project. For example, assuming a benchmark includes a minimal threshold of 12% project budget for QA, a recommendation may be “only 4% of the budget is assigned to Quality Assurance, consider increasing the QA budget to 12% of the project's budget”. The rule may be based on profiles of the company's project or based on project in the relevant industry (e.g., using data related to a large number of organizations that have similar projects). For example, the average portion of an entire project's budget spent on QA in software development projects may be defined or discovered by analyzing data related to a large number of software companies.

As shown by block 640, a system and method may include using the obtained and generated data to generate a prediction of a future event related to the project. For example, a prediction of an event may be a prediction of a date when a project will be completed. For example, a prediction may include a time or data when programming of a software project is completed, when testing of the software will be completed, when an application developed in a project will be ready for shipment or deployment etc. Other data in a prediction may be an amount of resource or asset spent, a “future” event, e.g., budget may be exhausted before planned end of project. A prediction may indicate a missed event, e.g., a milestone date will be missed.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method of predicting a performance of a project, the method comprising:
generating input data based on:
data related to one or more managerial systems of an organization, data related to one or more projects the organization is currently working on, and
historical data related to one or more past projects;
generating a benchmark based on events related to projects in one or more organizations; and
using the input data and the benchmark to generate a prediction of at least one future event related to the project.

2. The method of claim 1, comprising generating the benchmark based on at least one of: a time schedule of a project and resource allocation of a project.

3. The method of claim 1, wherein generating a prediction of a future event comprises processing, by a processing unit, data related to at least one of: tasks, resources, schedules of the project, history of the project, Gantt charts of the project and the benchmark.

4. The method of claim 1, comprising generating a behavior and schedule prediction of the project based on relating patterns, events and statistical deductions of the project with data in a database.

5. The method of claim 1, wherein the input data is generated based on information collected from a relevant community.

6. The method of claim 1, wherein the input data is related to a past behavior of a resource used for the project.

7. The method of claim 6, wherein data related to the past behavior includes resource profiling information related to at least one of: a performance, a scheduling accuracy and an average delay in completing tasks.

8. The method of claim 1, wherein generating a prediction of at least one future event related to the project includes determining a projected workload of a resource.

9. The method of claim 1, comprising generating a recommendation usable for improving a performance of the project based on analyzing an impact of changes on an outcome of one or more other projects.

10. The method of claim 1, wherein generating a prediction includes using information produced by machine learning of the input data and at least one event related to one of:
the project and another project.

11. A system for predicting a performance of a project, the system comprising:
a memory; and
a controller, the controller configured to:
generate input data based on:
data related to one or more managerial systems of an organization,
data related to one or more projects the organization is currently working on, and
historical data related to one or more past projects;
generate a benchmark based on events related to projects in one or more organizations; and
use the input data and the benchmark to generate a prediction of at least one future event related to the project.

12. The system of claim 11, wherein the controller is configured to generate the benchmark based on at least one of: a time schedule of a project and resource allocation of a project.

13. The method of claim 1, wherein generating a prediction of a future event comprises processing, by the controller, data related to at least one of: tasks, resources, schedules of the project, history of the project, Gantt charts of the project and the benchmark.

14. The method of claim 1, wherein the controller is configured to generate a behavior and schedule prediction of the project based on relating patterns, events and statistical deductions of the project with data in a database.

15. The method of claim 1, wherein the input data is generated based on information collected from a relevant community.

16. The method of claim 1, wherein the input data is related to a past behavior of a resource used for the project, the input data including resource profiling information related to at least one of: a performance, a scheduling accuracy and an average delay in completing tasks.

17. The method of claim 1, wherein generating a prediction of at least one future event related to the project includes determining a projected workload of a resource.

18. The method of claim 1, comprising generating a recommendation usable for improving a performance of the project based on analyzing an impact of changes on an outcome of one or more other projects.

19. The method of claim 1, wherein the controller is configured to generate a prediction includes using information produced by machine learning of the input data and at least one event related to one of: the project and another project.

20. A method of estimating an outcome of a project, the method comprising:
obtaining data from a managerial system;
obtaining data related to an ongoing project;
obtaining historical data related to one or more past projects;
generating a benchmark based on events related to projects in one or more organizations; and
using the obtained data and the benchmark to generate a prediction of at least one future event related to the ongoing project.
